(19) United States
(12) Patent Application Publication
(10) Pub. No.: US 2026/0241470 A1
(43) Pub. Date: Aug. 20, 2026

(54) BOLT CUTTER WITH FLAT STABILIZER

(71) Applicant: Apex Brands, Inc., Apex, NC (US)

(72) Inventor: Pratik Bendale, Concord, NC (US)

(21) Appl. No.: 19/160,596

(22) PCT Filed: Feb. 21, 2024
(86) PCT No.: PCT/US2024/016616

§ 371 Date: Aug. 28, 2025

Related U.S. Application Data
(60) Provisional application No. 63/487,472, filed on Feb. 28, 2023.

(51) Int. Cl. B23D 29/02

(52) U.S. Cl. CPC B23D 29/023

(57) ABSTRACT

A bolt cutter is provided that includes a cutter blade assembly, and a first handle assembly and a second handle assembly pivotably connected to the cutter blade assembly. The first handle assembly and the second handle assembly each include a free end opposite the cutter blade assembly. The bolt cutter includes a first handle grip fitted onto the free end of the first handle assembly, and a second handle grip fitted onto the free end of the second handle assembly. And the bolt cutter includes a flat located proximate the free end of the first handle assembly. The flat has a planar surface in a plane that is tangent to the cutter blade assembly when the bolt cutter is in an open position, the flat structured to stabilize the bolt cutter when the first handle assembly is braced on a work surface that lies in the plane.

### TECHNOLOGICAL FIELD

The present disclosure relates generally to hand tools and, in particular, to bolt cutters with a flat stabilizer.

### BACKGROUND

A number of hand tools are designed to cut through material. Bolt cutters are one example of a hand tool used for cutting through materials such as bolts, chains, wire mesh, and padlocks. They are widely used in many occupations, such as construction, mechanics, security and law enforcement.

Bolt cutters generally include two long handles pivotably connected to a pair of jaws, with the handles used to apply force to the jaws to cut through metals and other hard materials. Many bolt cutters include a compound hinge that allows a user to exert more force with less effort, making it easier to cut through tougher materials. The compound hinge also allows the user to apply increased leverage to the bolt cutter, making it much easier to cut through thick materials.

Bolt cutters are used in a variety of applications, from cutting through locks and chains to cutting through wire fencing. They are often used to break into locked areas or forcibly remove padlocks. They can also be used to cut wires for electrical work, as well as cutting through metal and plastic pipes. Bolt cutters are also used in automotive repair, as they can be used to remove seized bolts and other fasteners. Bolt cutters are an essential tool for many occupations and come in a variety of sizes and styles.

### BRIEF SUMMARY

Example implementations of the present disclosure are directed to a bolt cutter with a flat the flat structured to stabilize the bolt cutter when braced on a work surface. The present disclosure includes, without limitation, the following example implementations.

Some example implementations provide a bolt cutter comprising: a cutter blade assembly; a first handle assembly and a second handle assembly pivotably connected to the cutter blade assembly, the first handle assembly and the second handle assembly each including a free end opposite the cutter blade assembly; a first handle grip fitted onto the free end of the first handle assembly, and a second handle grip fitted onto the free end of the second handle assembly; and a flat located proximate the free end of the first handle assembly, the flat having a planar surface in a plane that is tangent to the cutter blade assembly when the bolt cutter is in an open position, the flat structured to stabilize the bolt cutter when the first handle assembly is braced on a work surface that lies in the plane.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 is a perspective view of a bolt cutter in a closed position, according to some example implementations of the present disclosure:

FIGS. 2 and 3 are respectively a side view and a bottom view of the bolt cutter, according to some example implementations;

FIGS. 4 and 5 are side views of the bolt cutter in an open position, according to some example implementations; and

FIG. 6 is an enlarged view of a first handle grip of the bolt cutter, according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form.

Example implementations of the present disclosure relate generally to hand tools and, in particular, to bolt cutters with a flat stabilizer.

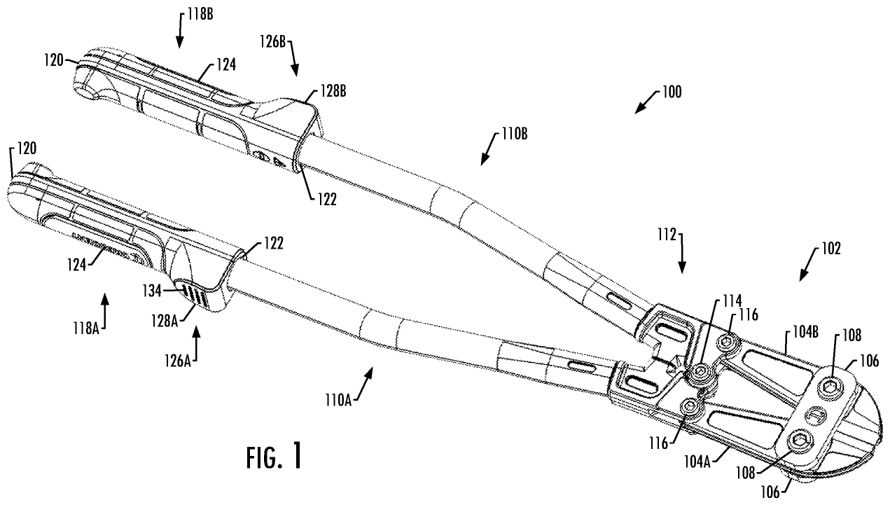

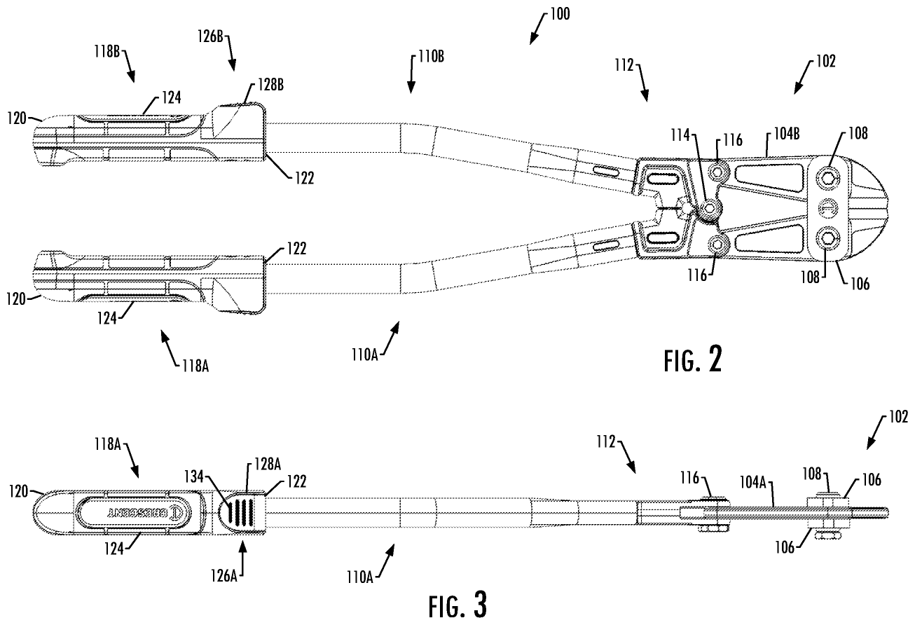

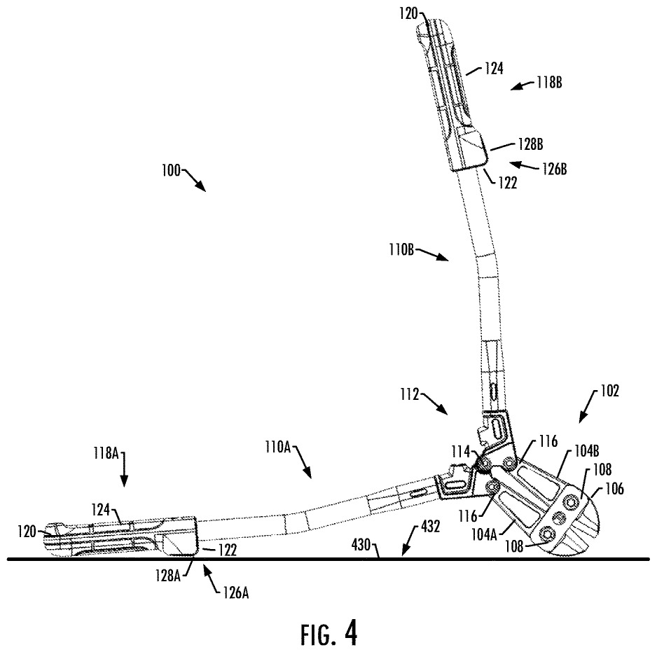

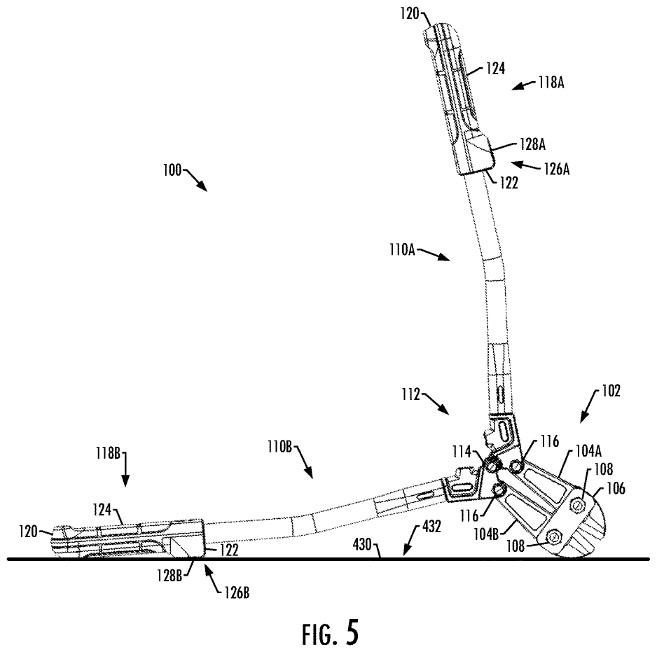

FIGS. 1, 2, 3, 4 and 5 illustrate a bolt cutter 100 according to some example implementations of the present disclosure. In FIGS. 1, 2 and 3, the bolt cutter is in a closed position; and in FIGS. 4 and 5, the bolt cutter is in an open position. As shown, the bolt cutter includes a cutter blade assembly 102 with a pair of jaws. In particular, the blade assembly includes a first jaw 104A and a second jaw 104B that are pivotably secured to one another at a jaw joint by plates 106 and fasteners 108 such as bolts. The pair of jaws include blades that are the cutting surfaces of the bolt cutter. The blades may be structured in a number of different manners for a number of different uses.

The bolt cutter 100 also includes a pair of handle assemblies, namely a first handle assembly 110A and a second handle assembly 110B. The first and second handle assemblies are pivotably connected to one another, and pivotably connected to the cutter blade assembly 102. In this regard, the bolt cutter provides a compound hinge arrangement of hinge joints and levers that allows a user to exert more force with less effort. As shown, the bolt cutter includes a pivot assembly 112 that defines a handle joint and a middle joint. The first and second handle assemblies are pivotably connected to one another at the handle joint by a fastener 114 (e.g., bolt). Similarly, the first and second jaws 104A, 104B of the blade assembly are pivotably connected to the first and second handle assemblies by fasteners 116 (e.g., bolts).

As also shown, the bolt cutter 100 includes a handle grip fitted onto a free end of each handle assembly, opposite the cutter blade assembly 102. In particular, the bolt cutter includes a first handle grip 118A fitted onto the free end of the first handle assembly 110A, and a second handle grip 118B fitted onto the free end of the second handle assembly 110B. Each handle grip includes a butt-end 120, and an open end 122 opposite the butt-end from which one of the handle assemblies extends. Each handle grip also includes a grip body 124 with a curved surface configured to be gripped by a user.

Although bolt cutters like bolt cutter 100 allow a user to exert more force with less effort, making it easier to cut through tougher materials when operated with the user gripping both of the handle grips 118A, 118B. Some materials, however, are sufficiently tough that the user may find it useful to brace one of the handle assemblies on a work surface, freeing both of the user's hands to apply force to the other handle assembly, rather than trying to close the bolt cutter while gripping both of the handle grips. The bolt cutter 100 therefore further includes a flat located proximate the free end of either or each of the handle assemblies 110A, 110B. The flat has a planar surface in a plane that is tangent to the cutter blade assembly 102 when the bolt cutter is in an open position, and the flat is structured to stabilize the bolt cutter when the one of the handle assemblies is braced on a work surface that lies in the plane.

The flat may be formed in a number of different manners. In some examples, the flat is formed at a boundary between one of the handle grips and the handle assembly onto which the handle grip is fit. The flat may be integrated with and protrude from one of the handle assemblies, or one of the handle grips that is fitted onto the free end of one of the handle assemblies. In other examples, the flat may be secured to and protrude from one of the handle assemblies or handle grips. As shown in the figures, the bolt cutter 100 includes a (first) flat 126A and a second flat 126B integrated with and protruding from respective ones of the first and second handle grips 118A, 118B, located proximate the free end of respective ones of the first and second handle assemblies 110A, 110B.

As shown in FIG. 4 in particular, the flat 126A has a planar surface 128A in a plane 430 that is tangent to the cutter blade assembly 102 when the bolt cutter is in an open position, structured to stabilize the bolt cutter when the first handle assembly is braced on a work surface 432 that lies in the plane. In particular, the plane is tangent to the first jaw 104A of the cutter blade assembly when the bolt cutter is in the open position. The flat may further include one or more lugs 134 to increase traction of the flat against the work surface. FIG. 5 more particularly illustrates the second flat 126B that has a respective planar surface 128B in a second plane 530 that is tangent to the cutter blade assembly (second jaw 104B) when the bolt cutter is in the open position. Similar to the first flat, the second flat is structured to stabilize the bolt cutter when the second handle assembly 110B is braced on a work surface 532 that lies in the second plane.

The flat 126A may be located proximate the open end 122 of the first handle grip 118A. The flat may adjoin grip body 124 and protrude from the curved surface of the grip body. And in some examples, the plane 430 of the planar surface 128A may also be tangent to the butt-end 120 of the first handle grip (regardless of whether the bolt cutter 100 is in the open position or closed position). The second flat 128B may be similarly located relative to the second handle grip 118B, with the plane 530 of the respective planar surface 128B of the second flat tangent to the butt-end of the second handle grip.

As shown in FIG. 4, the open position of the bolt cutter 100 at which the plane 430 of the planar surface 128A of the flat 126A is tangent to the cutter blade assembly 102 is less than but at least half of a fully open position. Similarly, in FIG. 5, the open position at which the plane 530 of the respective planar surface 128B of the second flat 126B is tangent to the cutter blade assembly 102 is less than but at least half of a fully open position of the bolt cutter 100. In other examples, either or both flat may be structured so that the plane of the planar surface is tangent to the cutter blade assembly when the bolt cutter is in its fully open position.

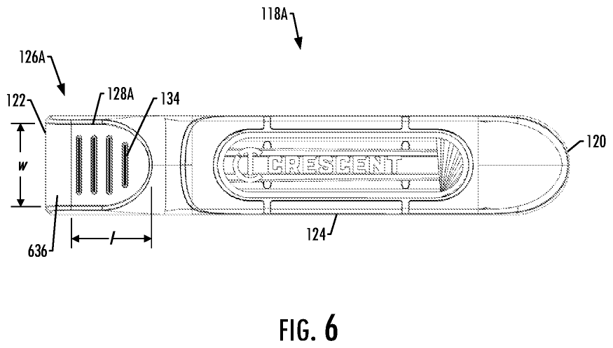

FIG. 6 is an enlarged view of the first handle grip 118A of the bolt cutter 100, more clearly illustrating the planar surface 128A of the flat 126A, according to some example implementations. The planar surface has a curved shape formed by the Boolean union of a half-ellipse and a rectangle. The rectangle of the curved shape of the planar surface is positioned closest to the open end 122 of the first handle grip, and the flat includes a curved transition 636 from the planar surface to the open end. This transition or edge of the flat may provide added stability when the bolt cutter is in the closed position, and the plane of the planar surface is not tangent to the cutter blade assembly 102. The planar surface has a length/and a width w; and as shown, the length and width are approximately the same. More generally, in some examples, the length of the planar surface is at least 75% as long as the width. Even more generally, the length and width may be sized to stabilize (and perhaps also balance) the bolt cutter.

As explained above and reiterated below, the present disclosure includes, without limitation, the following example implementations.

Clause 1. A bolt cutter comprising: a cutter blade assembly; a first handle assembly and a second handle assembly pivotably connected to the cutter blade assembly, the first handle assembly and the second handle assembly each including a free end opposite the cutter blade assembly; a first handle grip fitted onto the free end of the first handle assembly, and a second handle grip fitted onto the free end of the second handle assembly; and a flat located proximate the free end of the first handle assembly, the flat having a planar surface in a plane that is tangent to the cutter blade assembly when the bolt cutter is in an open position, the flat structured to stabilize the bolt cutter when braced on a work surface that lies in the plane.

Clause 2. The bolt cutter of clause 1, wherein the cutter blade assembly includes a first jaw and a second jaw, and the plane of the planar surface of the flat is tangent to the first jaw when the bolt cutter is in the open position.

Clause 3. The bolt cutter of clause 1 or clause 2, wherein the flat is formed at a boundary between the first handle grip and the first handle assembly.

Clause 4. The bolt cutter of any of clauses 1 to 3, wherein the flat is integrated with and protrudes from the first handle grip that is fitted onto the free end of the first handle assembly.

Clause 5. The bolt cutter of clause 4, wherein the first handle grip includes a butt-end, and an open end opposite the butt-end from which the first handle assembly extends, and wherein the flat is located proximate the open end of the first handle grip.

Clause 6. The bolt cutter of clause 5, wherein the plane of the planar surface of the flat is also tangent to the butt-end of the first handle grip.

Clause 7. The bolt cutter of any of clauses 4 to 6, wherein the first handle grip includes a grip body with a curved surface configured to be gripped by a user, and that adjoins the flat that protrudes from the curved surface.

Clause 8. The bolt cutter of any of clauses 1 to 7, wherein the flat includes one or more lugs to increase traction of the flat against the work surface.

Clause 9. The bolt cutter of any of clauses 1 to 8, wherein the planar surface of the flat has a length and a width, and the length is at least 75% as long as the width.

Clause 10. The bolt cutter of any of clauses 1 to 9, wherein the open position at which the plane of the planar surface is tangent to the cutter blade assembly is less than but at least half of a fully open position of the bolt cutter.

Clause 11. The bolt cutter of any of clauses 1 to 10, wherein the flat is a first flat, and the bolt cutter further comprises a second flat located proximate the free end of the second first handle assembly, the second flat having a respective planar surface in a second plane that is tangent to the cutter blade assembly when the bolt cutter is in the open position.

Clause 12. The bolt cutter of clause 11, wherein the cutter blade assembly includes a first jaw to which the plane of the planar surface of the first flat is tangent, and a second jaw to which the second plane of the respective planar surface of the second flat is tangent.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A bolt cutter comprising:
a cutter blade assembly;
a first handle assembly and a second handle assembly pivotably connected to the cutter blade assembly, the first handle assembly and the second handle assembly each including a free end opposite the cutter blade assembly;
a first handle grip fitted onto the free end of the first handle assembly, and a second handle grip fitted onto the free end of the second handle assembly; and
a flat located proximate the free end of the first handle assembly, the flat having a planar surface in a plane that is tangent to the cutter blade assembly when the bolt cutter is in an open position, the flat structured to stabilize the bolt cutter when the first handle assembly is braced on a work surface that lies in the plane.

2. The bolt cutter of claim 1, wherein the cutter blade assembly includes a first jaw and a second jaw, and the plane of the planar surface of the flat is tangent to the first jaw when the bolt cutter is in the open position.

3. The bolt cutter of claim 1, wherein the flat is formed at a boundary between the first handle grip and the first handle assembly.

4. The bolt cutter of claim 1, wherein the flat is integrated with and protrudes from the first handle grip that is fitted onto the free end of the first handle assembly.

5. The bolt cutter of claim 4, wherein the first handle grip includes a butt-end, and an open end opposite the butt-end from which the first handle assembly extends, and
wherein the flat is located proximate the open end of the first handle grip.

6. The bolt cutter of claim 5, wherein the plane of the planar surface of the flat is also tangent to the butt-end of the first handle grip.

7. The bolt cutter of claim 4, wherein the first handle grip includes a grip body with a curved surface configured to be gripped by a user, and that adjoins the flat that protrudes from the curved surface.

8. The bolt cutter of claim 1, wherein the flat includes one or more lugs to increase traction of the flat against the work surface.

9. The bolt cutter of claim 1, wherein the planar surface of the flat has a length and a width, and the length is at least 75% as long as the width.

10. The bolt cutter of claim 1, wherein the open position at which the plane of the planar surface is tangent to the cutter blade assembly is less than but at least half of a fully open position of the bolt cutter.

11. The bolt cutter of claim 1, wherein the flat is a first flat, and the bolt cutter further comprises a second flat located proximate the free end of the second first handle assembly,
wherein the second flat has a respective planar surface in a second plane that is tangent to the cutter blade assembly when the bolt cutter is in the open position, the second flat structured to stabilize the bolt cutter when the second handle assembly is braced on a work surface that lies in the second plane.

12. The bolt cutter of claim 11, wherein the cutter blade assembly includes a first jaw to which the plane of the planar surface of the first flat is tangent, and a second jaw to which the second plane of the respective planar surface of the second flat is tangent.
